(19) United States
(12) Patent Application Publication
(10) Pub. No.: US 2005/0069758 A1
(43) Pub. Date: Mar. 31, 2005

(54) Method of controlling charge and discharge of non-aqueous electrolyte secondary cell

(76) Inventors: Hideki Kitao, Kobe-city (JP); Toyoki Fujihara, Kobe-city (JP); Kouichi Satoh, Kobe-city (JP); Takaaki Ikemachi, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006, US

(21) Appl. No.: 10/951,860

(22) Filed: Sep. 29, 2004

(30) Foreign Application Priority Data
Sep. 29, 2003 (JP) 2003-337024
Aug. 25, 2004 (JP) 2004-244653

(51) Int. Cl. H01M 10/44; H01M 4/58; H01M 4/50

(52) U.S. Cl. 429/50; 429/231.1; 429/224; 429/231.4

(57) ABSTRACT

Good cycle performance and high discharge power characteristics are obtained with a non-aqueous secondary cell including a positive electrode containing as a positive electrode active material a mixture of a lithium-manganese composite oxide and a lithium-transition metal composite oxide containing at least Ni and Mn, and a negative electrode having as a negative electrode active material a material capable of intercalating and deintercalating lithium. Discharge of the non-aqueous secondary cell is controlled so that the end-of-discharge voltage of the non-aqueous secondary cell becomes equal to or higher than 2 V and lower than 3 V.

### BACKGROUND OF THE INVENTION

1. Field of the Invention

The present invention relates to methods of controlling charge and discharge of non-aqueous electrolyte secondary cells such as lithium secondary cells.

2. Description of Related Art

A problem with non-aqueous electrolyte secondary cells that use manganese oxide having a spinel structure as an active material has been that the structure of the manganese oxide degrades due to a phase change associated with charging, causing cell performance to deteriorate. Japanese Patent No. 3024636 discloses that degradation in high-temperature storage performance can be suppressed by mixing a Li—Ni—Co composite oxide with such a manganese oxide having a spinel structure. In the method disclosed in the above-noted publication, the end-of-discharge voltage is set at 3.0 V, and the method is unable to obtain high discharge power characteristics.

In high power lithium ion cells, since a large discharge current flows within a short period of time, a voltage drop occurs due to a resistance component originating from electrode active materials and current collectors; therefore, with an end-of-discharge voltage of 3.0 V, it has not been possible to have a large current flow. When discharge is performed in a region of 3 V or lower with the cells that use only manganese oxide having a spinel structure, a tetragonal structure of Li₁₊ₛMn₂O₄ results due to an irreversible reaction, which may degrade the cycle performance. On the other hand, it has not been possible to achieve sufficient high temperature storage performance when only a Li—Ni—Mn composite oxide is used.

### BRIEF SUMMARY OF THE INVENTION

It is an object of the present invention to provide a method of controlling charge and discharge of a non-aqueous electrolyte secondary cell that uses a mixture of Li—Ni—Mn composite oxide and lithium-manganese oxide as a positive electrode active material, the method being capable of achieving high discharge power characteristics as well as good cycle performance.

The present invention provides a method of controlling charge and discharge of a non-aqueous secondary cell comprising a positive electrode having as a positive electrode active material a mixture of a lithium-transition metal composite oxide containing at least Ni and Mn (hereinafter sometimes referred to simply as a lithium-transition metal composite oxide) and a lithium-manganese composite oxide, and a negative electrode having as a negative electrode active material a material capable of intercalating and deintercalating lithium, the method comprising: controlling discharge of the non-aqueous secondary cell so that the end-of-discharge voltage of the non-aqueous secondary cell is equal to or higher than 2 V and lower than 3 V.

High discharge power characteristics and good cycle performance can be attained by controlling discharge of the cell so that the end-of-discharge voltage becomes equal to or higher than 2 V and less than 3 V according to the present invention.

In the present invention, the discharge of the non-aqueous secondary cell may be controlled by a control circuit so that the end-of-discharge voltage becomes equal to or higher than 2 V and less than 3 V. Such a control circuit is generally incorporated in the non-aqueous secondary cell or an assembled battery having a plurality of cells each being the secondary cell, or in an apparatus using the secondary cell or the assembled battery. Control circuits useful in the present invention are known in the art and include those described in U.S. Pat. Nos. 6,396,246 and 6,492,791, which are incorporated herein by reference.

In the present invention, the lithium-transition metal composite oxide may further contain at least one element selected from the group consisting of B, Mg, Al, Ti, V, Fe, Co, Cu, Zn, Ga, Y, Zr, Nb, Mo, and In.

In the present invention, it is preferable that the lithium-transition metal composite oxide further contain cobalt. Specifically, it is preferable that the lithium-transition metal composite oxide contain Ni, Mn, and Co as transition metals. It is preferable that such a lithium-transition metal composite oxide be represented by the chemical formula LiₐMnₓNi_{y}Co_{z}O₂, wherein a, x, y, and z satisfy the equations: 0≦a≦1.2; x+y+z=1; 0<x≦0.5; 0<y≦0.5; and z≧0.

In the present invention, it is preferable that the lithium-manganese composite oxide have a spinel structure. The lithium-manganese composite oxide may further contain at least one element selected from the group consisting of B, Mg, Al, Ti, V, Fe, Co, Cu, Zn, Ga, Y, Zr, Nb, Mo, and In.

In the present invention, from the standpoint of obtaining an optimum balance of good cycle performance and good high-temperature storage performance, it is preferable that the mixing ratio of the lithium-transition metal composite oxide and the lithium-manganese composite oxide be within a range of from 9:1 to 1:9 by weight (lithium-transition metal composite oxide: lithium-manganese composite oxide), more preferably within a range of 9:1 to 2:8, still more preferably within a range of 9:1 to 4:6, and further more preferably within a range of 9:1 to 6:4. The greater the proportion of the lithium-transition metal composite oxide, the greater the improvement in the cycle characteristics. However, when the ratio of lithium-transition metal composite oxide to lithium-manganese composite oxide is greater than 9:1 or the lithium-transition metal composite oxide is used alone, other characteristics and, particularly, high-temperature storage performance may be deteriorated. If the ratio of lithium-transition metal composite oxide to lithium-manganese composite oxide is less than 1:9, i.e., the proportion of the lithium-manganese composite oxide becomes too large, degradation in cycle performance may occur along with a decrease in the end-of-discharge voltage.

Moreover, in the present invention, the negative electrode active material is preferably, but not particularly limited to, a carbon material. Among carbon materials, graphite materials are particularly preferable. Among the graphite materials, a low-crystallinity-carbon coated graphite is particularly preferable.

A low-crystallinity-carbon coated graphite is such that at least a portion of the surface of a graphite material, which serves as a core material, is coated with carbon material that has a lower crystallinity than the graphite material. Such a low-crystallinity-carbon coated graphite can be produced by contacting graphite powder with a hydrocarbon in a heated state. Also it should be noted that the low-crystallinity-carbon coated graphite is such that its intensity ratio (IA/IB), which is the ratio of intensity IA at 1350 cm⁻¹ and intensity IB at 1580 cm⁻¹, obtained by Raman spectroscopy, falls within a range of 0.2 to 0.3. The peak at 1580 cm⁻¹ originates from the stacked layers with hexagonal symmetry, similar to the graphite structure, and the peak at 1350 cm⁻¹ originates from a disordered crystalline structure of a carbon electrode part. The greater the value of IA/IB, the larger the proportion of the low crystallinity carbon on the surface. If the value of the above-noted ratio IA/IB becomes less than 0.2, the proportion of the lower crystallinity carbon on the graphite surface is too small, making it difficult to sufficiently increase the capability of receiving lithium ions. On the other hand, if the value of the ratio IA/IB exceeds 0.3, the amount of the lower crystallinity carbon is too large and the proportion of graphite is reduced, leading to degradation in cell capacity.

The solvent of the non-aqueous electrolyte used in the present invention may be any solvent that has conventionally been used as a solvent for an electrolyte in non-aqueous electrolyte secondary batteries. Examples of such a solvent include: cyclic carbonates such as ethylene carbonate, propylene carbonate, butylene carbonate, and vinylene carbonate; and chain carbonates such as dimethyl carbonate, methylethyl carbonate, and diethyl carbonate. In particular, a mixed solvent of a cyclic carbonate and chain carbonate is preferable.

In the present invention, the solute of the non-aqueous electrolyte may be any lithium salt that is generally used as a solute in non-aqueous electrolyte secondary batteries. Examples of such a lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂Bl₂Cl₁₂, and mixtures thereof.

According to the present invention, high discharge power characteristics as well as good cycle performance can be obtained.

### BRIEF DESCRIPTION OF THE DRAWINGS

FIG. 1 is a graph showing the relationship between end-of-discharge voltages and maximum discharge output currents, with varying end-of-discharge voltages;

FIG. 2 is a graph showing the relationship between mixing ratios of lithium-transition metal composite oxide and lithium-manganese composite oxide and capacity retention ratios, with varying mixing ratios.

FIG. 3 is a graph showing a discharge curve of a comparative example when the end-of-discharge voltage is set to be lower than 2.0 V.

### DETAILED DESCRIPTION OF THE PREFERRED EMBODIMENTS

Hereinbelow, preferred embodiments of the present invention are described by way of examples thereof. It should be understood, however, that the present invention is not limited to the following examples but various changes and modifications are possible unless such changes and variations depart from the scope of the invention.

### EXPERIMENT 1

### EXAMPLE 1

Preparation of Positive Electrode

A powder of LiNi_{0.4}Co_{0.3}Mn_{0.3}O₂ and a powder of LiMn₂O₄ were mixed as positive electrode active material so that the weight ratio (lithium-transition metal composite oxide: lithium-manganese composite oxide) became 7:3. Into the powder mixture, artificial graphite serving as a conductive agent was mixed so that the weight (powder mixture: artificial graphite) became 9:1. Thus, a positive electrode mixture was prepared. The positive electrode mixture thus prepared was mixed into a N-methyl-2-pyrrolidone (NMP) solution containing 5 weight % poly(vinylidene fluoride) (PVdF), serving as a binder, so that the solid content weight ratio (positive electrode mixture: binder) became 95:5, to prepare a slurry. The slurry was applied onto both sides of an aluminum foil having a thickness of 20 μm by doctor blading, and then vacuum dried at 150° C. for 2 hours. Thus, a positive electrode was prepared.

Preparation of Negative Electrode

PVdF, serving as a binder, was dissolved into NMP to prepare a NMP solution, followed by mixing graphite powder (IA/IB ratio=0.22) therewith so that the weight ratio of the graphite powder to PVdF (graphite powder: PVdF) became 85:15 to prepare a slurry. The slurry was applied onto both sides a copper foil having a thickness of 20 μm. A negative electrode was thus prepared.

Preparation of Electrolyte Solution

LiPF₆ was dissolved in a solvent in which ethylene carbonate and diethyl carbonate were mixed at a volume ratio of 1:1 so that the concentration of LiPF₆ became 1 mole/liter. An electrolyte solution was thus prepared.

Assembling of Cell

An ion-permeable microporous polypropylene film, serving as a separator, was wound around several times, and thereafter, the negative electrode and the positive electrode with the separator were spirally wound around a large number of times so that the negative electrode and the positive electrode opposed each other with the separator interposed therebetween. Thus, an electrode assembly was prepared. The electrode assembly was inserted into a battery can, and the above-described electrolyte solution was poured into the battery can, which was then sealed. Thus, a 1200 mAh cell was prepared.

Measurement of Rated Capacity of the Cell

Capacity of the cell was confirmed as follows. The cell was charged to 4.2 V with a 1C (1200 mA) constant current-constant voltage (cut-off 2.5 hours), thereafter the end-of-discharge voltage was set to be 2.0 V, and the cell was discharged to 2.0 V at a 1C rate. The discharge capacity thus obtained was defined as a rated capacity.

Measurement of Output Characteristic

The charged state in which half the capacity of the rated capacity was discharged from the fully-charged state was defined as 50% SOC. The cell was discharged in a constant temperature bath kept at −15° C. from 50% SOC with 1C to 10C for 10 seconds. The end-of-discharge voltage was set at 2 V, and the current value at which the end-of-discharge voltage was reached was taken as a maximum discharge output current.

Cycle Test

After the rated capacity of the cell was confirmed, the cell was charged to 4.2 V with a 1C constant current-constant voltage in a constant temperature bath kept at 45° C., thereafter the end-of-discharge voltage was set at 2.0 V, and the cell was discharged to 2.0 V at a 1C rate; then, this cycle was repeated. The capacity retention ratio was calculated by dividing the discharge capacity after a certain cycle by the discharge capacity at the initial stage of cycles (cycle 1).

The results of the measurements are shown in Tables 1 and 2 below.

### EXAMPLE 2

Each of the tests were performed in the same manner as in Example 1 except that the end-of-discharge voltage was set at 2.5 V. The results are shown in Tables 1 and 2.

### EXAMPLE 3

Each of the tests were performed in the same manner as in Example 1 except that the end-of-discharge voltage was set at 2.75 V. The results are shown in Tables 1 and 2.

### COMPARATIVE EXAMPLE 1

Each of the tests were performed in the same manner as in Example 1 except that the end-of-discharge voltage was set at 3.0 V. The results are shown in Tables 1 and 2.

### COMPARATIVE EXAMPLE 2

The cycle test was performed in the same manner as in Comparative Example 1, with the end-of-discharge voltage being set at 3.0 V, except that only LiMn₂O₄ was used as the positive electrode active material. The result is shown in Table 1.

### COMPARATIVE EXAMPLE 3

The cycle test was performed in the same manner as in Comparative Example 2 except that the end-of-discharge voltage was set at 2.0 V. The result is shown in Table 1.

### COMPARATIVE EXAMPLE 4

The cycle test was performed in the same manner as in Comparative Example 1 except that the end-of-discharge voltage was set at 1.8 V. The result is shown in Table 1.

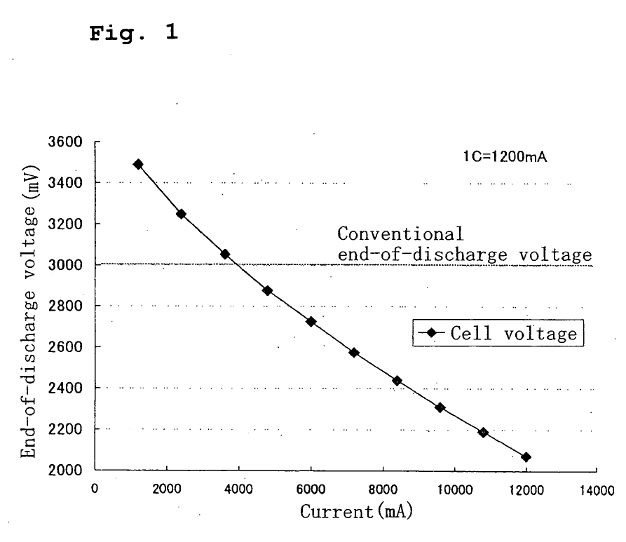

The relationship between end-of-discharge voltage and maximum discharge current with varying end-of-discharge voltages is shown in FIG. 1.

TABLE 1

| | Capacity retention ratio |
|---|---|
| | at cycle 50 |
| Ex. 1 | 96% |
| End-of-discharge voltage 2.0 V | |
| Ex. 2 | 94% |
| End-of-discharge voltage 2.5 V | |
| Ex. 3 | 94% |
| End-of-discharge voltage 2.75 V | |
| Comp. Ex. 1 | 94% |
| End-of-discharge voltage 3.0 V | |
| Comp. Ex. 2 | 91% |
| End-of-discharge voltage 3.0 V | |
| Comp. Ex. 3 | 89% |
| End-of-discharge voltage 2.0 V | |
| Comp. Ex. 4 | 90% |
| End-of-discharge voltage 1.8 V | (at cycle 10) |

TABLE 2

| | Maximum discharge output |
|---|---|
| | current |
| Ex. 1 | 12 A |
| End-of-discharge voltage 2.0 V | |
| Ex. 2 | 8 A |
| End-of-discharge voltage 2.5 V | |
| Ex. 3 | 6 A |
| End-of-discharge voltage 2.75 V | |
| Comp. Ex. 1 | 4 A |
| End-of-discharge voltage 3.0 V | |

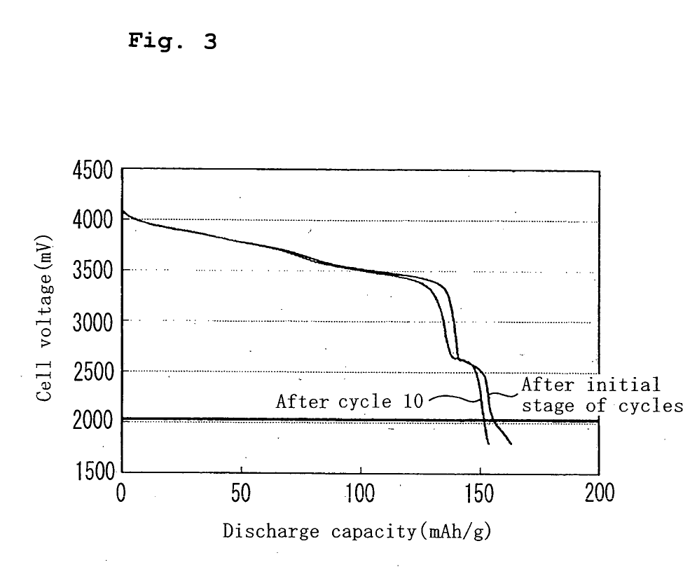

Table 1 clearly demonstrates that it is possible to obtain cycle performance that is comparable to or better than the case of 3.0 V, which is a conventional end-of-discharge voltage, by setting the end-of-discharge voltage to be equal to or higher than 2.0 V and lower than 3.0 V. In addition, as with Comparative Example 4, if the end-of-discharge voltage is set to be lower than 2.0 V, the discharge curve after cycle 10 became different from the discharge curve at the initial stage of cycles, as shown in FIG. 3. The reason is thought to be that if the end-of-discharge voltage is set to be lower than 2.0 V, a transition of crystal structure occurs that causes the lithium intercalation and deintercalation of the lithium-manganese oxide to become irreversible. As a result, as shown in Table 1, with Comparative Example 4, in which the end-of-discharge voltage is set to be lower than 2.0 V, its capacity retention ratio reduces to 90% as early as cycle 10 and thereafter, indicating a considerable degradation in cycle performance. Accordingly, it is understood that a cell having good cycle performance can be obtained by setting the end-of-discharge voltage to be 2.0 V or higher. Furthermore, Table 2 and FIG. 1 clearly demonstrate that a high discharge power characteristic can be obtained by setting the end-of-discharge voltage to be equal to or higher than 2.0 V and lower than 3.0 V.

### EXPERIMENT 2

Positive electrodes having varying mixing ratios of lithium-transition metal composite oxide and lithium-manganese composite oxide as shown in Table 3 were prepared in order to study the influence of the mixing ratios of lithium-transition metal composite oxide and lithium-manganese composite oxide on cell performance. The method of the preparation was the same as that of Example 1, and cells were prepared in the same manner as Example 1.

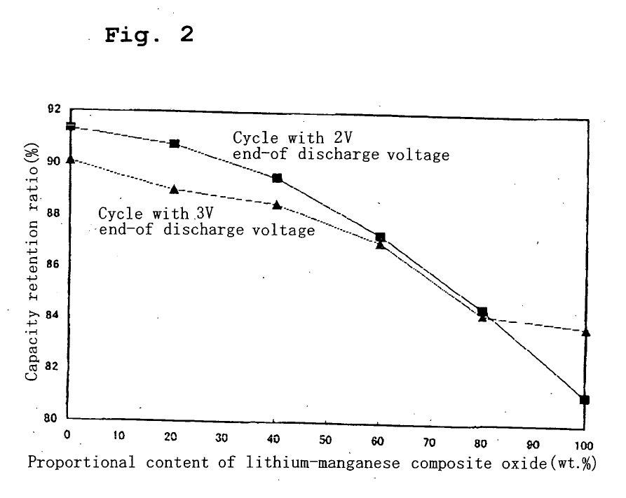

Cycle performance of each of the cells thus prepared was evaluated both in the case where the end-of-discharge voltage was 2.0 V and in the case where the end-of-discharge voltage was 3.0 V. Cycle performance was measured in accordance with the same cycle test as that in Example 1 except that the number of cycles was 200. Capacity retention ratios were calculated by dividing discharge capacities at cycle 200 by discharge capacities at the first cycle (the initial stage of cycles). The results are shown in Table 3 and FIG. 2.

TABLE 3

| | Capacity | Capacity |
|---|---|---|
| | retention ratio | retention ratio |
| | for cycles with | for cycles with |
| Mixing ratio | end-of-discharge | end-of-discharge |
| Li-transition metal | voltage of 2 V | voltage of 3 V |
| composite oxide: | (cycle 200) | (cycle 200) |
| Li—Mn composite oxide | (%) | (%) |
| 10:0 | 91.6 | 90.0 |
| 8:2 | 90.9 | 89.0 |
| 6:4 | 89.8 | 88.5 |
| 4:6 | 87.5 | 87.0 |
| 2:8 | 84.5 | 84.3 |
| 0:10 | 81.2 | 83.9 |

Table 3 and FIG. 2 clearly demonstrate that cycle performance improved when the end-of-discharge voltage was set at 2.0 V and the mixing ratios of lithium-transition metal composite oxide to lithium-manganese composite oxide was 2:8 and greater. Although good cycle performance was obtained even when the lithium-transition metal composite oxide was used alone, high-temperature storage performance is deteriorated. Thus, it is preferable that the mixing ratio be in a range of 9:1 to 2:8, more preferably 9:1 to 4:6, and still more preferably 9:1 to 6:4.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

1. A method of controlling charge and discharge of a non-aqueous secondary cell comprising a positive electrode comprising as a positive electrode active material a mixture of a lithium-transition metal composite oxide containing at least Ni and Mn and a lithium-manganese composite oxide, and a negative electrode comprising as a negative electrode active material a material capable of intercalating and deintercalating lithium, the method comprising:
controlling discharge of the non-aqueous secondary cell so that the end-of-discharge voltage of the non-aqueous secondary cell is equal to or higher than 2 V and lower than 3 V.

2. The method according to claim 1, wherein the lithium-transition metal composite oxide further contains at least one element selected from the group consisting of B, Mg, Al, Ti, V, Fe, Co, Cu, Zn, Ga, Y, Zr, Nb, Mo, and In.

3. The method according to claim 1, wherein the lithium-transition metal composite oxide is represented by the chemical formula LiₐMnₓNi_{y}Co_{z}O₂, where a, x, y, and z satisfy the equations: 0≦a≦1.2; x+y+z=1; 0<x≦0.5; 0<y≦0.5; and z≧0.

4. The method according to claim 1, wherein the lithium-manganese composite oxide has a spinel structure.

5. A method of controlling charge and discharge of a non-aqueous secondary cell comprising a positive electrode comprising as a positive electrode active material a mixture of a lithium-transition metal composite oxide containing at least Ni and Mn and a lithium-manganese composite oxide, and a negative electrode comprising as a negative electrode active material a material capable of intercalating and deintercalating lithium, the method comprising:
controlling discharge of the non-aqueous secondary cell so that the end-of-discharge voltage of the non-aqueous secondary cell is equal to or higher than 2 V and lower than 3 V; wherein
the lithium-manganese composite oxide has a spinel structure.

6. The method according to claim 5, wherein the lithium-transition metal composite oxide further contains at least one element selected from the group consisting of B, Mg, Al, Ti, V, Fe, Co, Cu, Zn, Ga, Y, Zr, Nb, Mo, and In.

7. The method according to claim 5, wherein the lithium-transition metal composite oxide is represented by the chemical formula LiₐMnₓNi_{y}Co_{z}O₂, where a, x, y, and z satisfy the equations: 0≦a≦1.2; x+y+z=1; 0<x≦0.5; 0<y≦0.5; and z≧0.

8. The method according to claim 7, wherein the negative electrode active material includes graphite.

9. A method of controlling charge and discharge of a non-aqueous secondary cell comprising a positive electrode comprising as a positive electrode active material a mixture of a lithium-transition metal composite oxide containing at least Ni and Mn and a lithium-manganese composite oxide, and a negative electrode comprising as a negative electrode active material a material capable of intercalating and deintercalating lithium, the method comprising:
controlling discharge of the non-aqueous secondary cell so that the end-of-discharge voltage of the non-aqueous secondary cell is equal to or higher than 2 V and lower than 3 V; wherein:
the lithium-manganese composite oxide has a spinel structure; and
the graphite is a low-crystallinity-carbon coated graphite comprising graphite material and carbon material, the graphite material serving as a core material, and the carbon material having a lower crystallinity than the graphite material and covering at least a portion of a surface of the graphite material.

10. The method according to claim 9, wherein the lithium-transition metal composite oxide further contains at least one element selected from the group consisting of B, Mg, Al, Ti, V, Fe, Co, Cu, Zn, Ga, Y, Zr, Nb, Mo, and In.

11. The method according to claim 9, wherein the lithium-transition metal composite oxide is represented by the chemical formula LiₐMnₓNi_{y}Co_{z}O₂, where a, x, y, and z satisfy the equations: 0≦a≦1.2; x+y+z=1; 0<x≦0.5; 0<y≦0.5; and z≧0.

12. The method according to claim 9, wherein, by a control circuit incorporated in the non-aqueous secondary cell or an assembled battery having a plurality of cells each being the secondary cell, or in an apparatus using the secondary cell or the assembled battery, the discharge of the secondary cell or each of the cells in the assembled battery is controlled.

13. The method according to claim 1, wherein, by a control circuit incorporated in the non-aqueous secondary cell or an assembled battery having a plurality of cells each being the secondary cell, or in an apparatus using the secondary cell or the assembled battery, the discharge of the secondary cell or each of the cells in the assembled battery is controlled.
